(19) United States
(12) Patent Application Publication
(10) Pub. No.: US 2014/0057711 A1
(43) Pub. Date: Feb. 27, 2014

(54) SYSTEM AND METHOD FOR PROVIDING CONTROL OVER VIDEOGAME CONTENT TO USERS DISCOVERING THE CONTENT

(71) Applicant: MASLOW SIX ENTERTAINMENT, INC., SAN MATEO, CA (US)

(72) Inventors: Derek HARP, San Mateo, CA (US); Bengt GREGORY-BROWN, Springfield, OH (US)

(73) Assignee: MASLOW SIX ENTERTAINMENT, INC., SAN MATEO, CA (US)

(21) Appl. No.: 14/069,182

(22) Filed: Oct. 31, 2013

Related U.S. Application Data
(63) Continuation of application No. 13/103,825, filed on May 9, 2011.

(51) Int. Cl. A63F 13/00

(52) U.S. Cl. CPC A63F 13/00
USPC 463/29

(57) ABSTRACT

Discovery rights to discoverable in-game content is provided to players of a videogame. The discovery rights to a given set of discoverable content in the videogame provide a player or group of players to which they are assigned control over one or more aspects of the given set of discoverable content. This control may be observable by other players or groups of players of the videogame, and may be exclusive to the assigned user or user group. The provision of discovery rights may encourage a more complete exploration of a videogame by players or groups in an effort to obtain more discovery rights. The discovery rights may provide discovering players or groups with status within the videogame, an opportunity to reward friends and/or impede the progress of rivals, an opportunity to obtain value within the videogame, and/or provide other advantages to discovering players. Discovery rights may be transferable between players or groups.

### FIELD OF THE INVENTION

The invention relates to the provision of a videogame to players in which sets of discoverable content are associated with discovery rights assigned to individual players or identified groups of players. The discovery rights provide the individual players or groups of players with some control over the sets of discoverable content within the videogame.

### BACKGROUND OF THE INVENTION

Various game mechanics for rewarding players for exploring videogames and/or virtual spaces are known. Such known mechanics may include one or more of unlockable content, awards or achievements, virtual object “drops”, and skill acquisition/refinement. Generally, these mechanics provide a reward to players for their exploration efforts that has been predetermined and fixed by the developer. Many of these mechanics provide the same benefit to any player that discovers some set of content in a game or space that has been linked to a benefit. As such, becoming the first to experience content is not recognized officially within the game. Further, many mechanics for rewarding players become associated with the player, and not the content they have experienced in an exploratory manner.

### SUMMARY

One aspect of the invention relates to a system and method of providing discovery rights to discoverable in-game content to players of a videogame. The discovery rights to a given set of discoverable content in the videogame provide a player or group of players to which they are assigned control over one or more aspects of the given set of discoverable content. This control may be observable by other players of the videogame, and may be exclusive to the assigned user. The provision of discovery rights may encourage a more complete exploration of a videogame by players in an effort to obtain more discovery rights. The discovery rights may provide discovering players or groups of players with status within the videogame, an opportunity to reward friends/allies/allied groups and/or impede the progress of rival players or player groups, an opportunity to obtain value within the videogame, and/or provide other advantages to discovering players and/or their associated groups. Discovery rights may be transferable between players or player groups.

A system configured to provide discovery rights to discoverable in-game content to users may include a one or more processors configured to execute computer program modules. The computer program modules may include one or more of a game module, a discovery module, a registry module, a rights module, a transaction module, and/or other modules.

The game module may be configured to generate views of a videogame for presentation to one or more players that enable the individual players to participate in the videogame by controlling corresponding player controlled objects within the videogame. The videogame comprising a plurality of sets of discoverable content, with individual sets of discoverable content are associated with corresponding discovery rights.

A set of discoverable content may include, for example, a place in the videogame, a passageway from one place to another place in the videogame, an object in the videogame, a recipe in the videogame, a non-player character in the videogame, a series of control inputs associated with an attack or character animation, a hidden/partially obscured image, information about game content, and/or other sets of content.

The discovery rights for a given set of discoverable content may provide control over certain aspects of the set of discoverable content. As is discussed herein, discovery rights may be awarded to a player or group of players of the videogame for “discovering” the discoverable content. Since the virtual space of the videogame may be common between a plurality players, and may be persistent independently from the plurality of players, an award of a discovery right to a player or group of players may be apparent to the other players of the videogame. For example, the other players may be impacted by the award of the discovery right to the player(s), and/or the award and/or possession of the discovery right (or the results of the exercise of the discovery right) may be observable by the other players in the videogame.

Discovery rights for a given set of discoverable content in the videogame may include rights other than (or in addition to) possession of virtual objects and/or places in the videogame. The aspects for which the discovery rights provide control over a set of discoverable content may include one or more of a name of the set of discoverable content, an ability of other players to make or use the set of discoverable content, visual presentation within the videogame, and/or other aspects of the discoverable content. A discovery right may include a right to receive a benefit for subsequent encounters with the discoverable content by other players.

The discovery module may be configured to detect encounters of players with individual sets of discoverable content while participating in the videogame. The discovery module may be configured to detect such encounters by monitoring operation of the game module, by querying the game module, by receiving communications generated by the game module, and/or from information received in other manners.

The registry module may be configured to maintain a registry of discovery rights associated with sets of discoverable content that are assigned to players in the videogame. The registry module may further be configured such that responsive to detection by the discovery module of an encounter of a given player or group of players with a first set of discoverable content, the registry module determines whether a first discovery right associated with the first set of discoverable content is assigned to any player(s). Responsive to determination that the first discovery right has not been assigned to any player(s), the registry module may be configured to update the registry to reflect that the first discovery right is assigned to the given player(s). Responsive to determination that the first discovery right has been assigned to a player or group of players, the registry module determines an identity of the player(s) to whom the first discovery right has been assigned.

The rights module is configured to provide discovery rights to the assigned players within the videogame. This may include, responsive to the registry module assigning the first discovery right to the given player(s), providing the first discovery right to the given player(s). One or more aspects of the control over the first set of discoverable content may be configurable by the given player(s). As such, the rights module may be configured to generate one or more user interfaces configured to receive entry and/or selection from the given player(s) of inputs configuring the first discovery right. Such inputs may define one or more of a name for the first set of discoverable content, a price for other players to encounter the first set of discoverable content, a common characteristic used to determined whether other players are able to subsequently encounter the first set of discoverable content, identities of individual characters and/or players that should be permitted to subsequently encounter the first set of discoverable content, and/or other aspects of the first set of discoverable content.

By way of non-limiting example, in some implementations, the first discovery right may include a naming right. In such implementations, providing the first discovery right to the player or group of players includes receiving (e.g., through a user interface provided by the rights module) a name for the first set of discoverable content in the videogame. The received name may then be associated the first set of discoverable content during subsequent encounters with the first set of discoverable content by other players.

In some implementations, the first discovery right comprises a right to a benefit for subsequent encounters with the first set of discoverable content by other players. The benefit could be a benefit that is provided by the videogame without cost to the other players. The benefit could be at least part of a price paid by the other players for access to the first set of discoverable content. In such implementations, providing the first discovery right to the given player(s) includes bestowing the benefit to the player(s) responsive to a subsequent encounter with the first set of discoverable content by another player or group of players.

In some implementations, the first discovery right comprises a right to exclude other players from subsequently encountering the first set of discoverable content. In such implementations, providing the first discovery right to the given player(s) includes selectively excluding other players from subsequently encountering the first set of discoverable content responsive to input from the given player(s). For example, the input from the given player(s) may indicate whether the other players should receive access to the first set of discoverable content on an individual and/or group basis. The input from the given player(s) may indicate a common characteristic to be used in determining whether other players should receive access to the first set of discoverable content.

The transaction module may be configured to facilitate transactions between players in which discovery rights for sets of discoverable content can be bought, sold, traded, given, and/or otherwise exchanged between players. Such transactions may involve exchanges of, in addition to discovery rights, virtual currency, real world currency, information, virtual objects, alliances, relationships, and/or other consideration. A transaction between a discovering player or group of players and another player or group of players of a discovery right may result in the registry maintained by the registry module indicating that the discovery right is assigned to the other player(s). Discovery rights may be exchanged individually and/or in sets that correspond to individual sets of discoverable content.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide discovery rights to discoverable in-game content to players of a videogame.

FIG. 2 illustrates a user interface configured to receive entry and/or selection of inputs from a player or group of players dictating the presentation and/or appearance of a set of discoverable content in a videogame.

FIG. 3 illustrates a user interface configured to receive entries and/or selections of a discovering player or group of players that dictate aspects of the ability of other players to make or use a set of discoverable content in a videogame.

FIG. 4 illustrates a user interface that may be presented to a discovering player or group of players responsive to another player or group of players encountering, or attempting to encounter, a set of discoverable content previously discovered by the discovering player(s) in a videogame.

FIG. 5 illustrates a method of providing, to a user, a discovery right over a set of discoverable content in a videogame.

### DETAILED DESCRIPTION

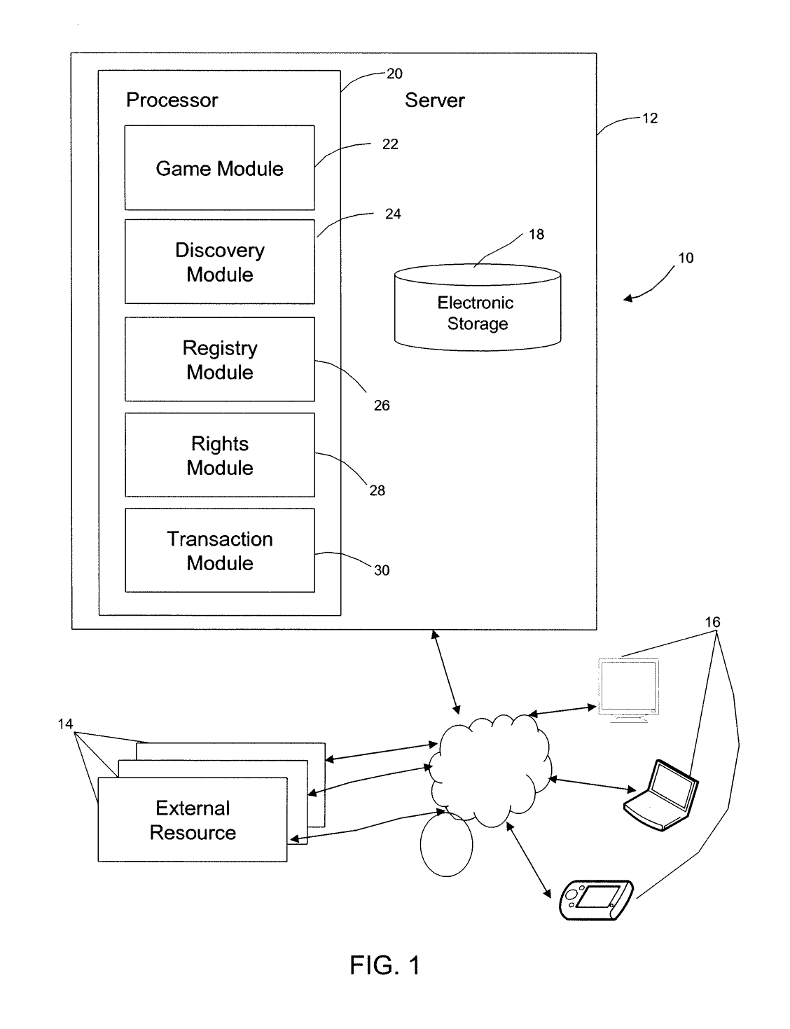

FIG. 1 illustrates a system 10 configured to provide discovery rights to discoverable in-game content to players of a videogame. The provision of discovery rights may encourage a more complete exploration of a videogame by players or groups of players, in an effort to obtain more discovery rights. Discovery rights may include rights over discoverable content that are assigned to discovering players or groups of players. The discovery rights may provide discovering players or groups of players with status within the videogame, an opportunity to reward friends/allies and/or impede the progress of rivals, an opportunity to obtain value within the videogame, and/or provide other advantages to discovering players. Discovery rights may be transferable between players or groups of players.

In some implementations, system 10 may include one or more servers 12, and/or other components. The system 10 may operate in communication and/or coordination with one or more external resources 14. Players or groups of players may interface with system 10 and/or external resources 14 via client computing platforms 16. The components of system 10, servers 12, external resources 14, and/or client computing platforms 16 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, external resources 14, and/or client computing platforms 16 may be operatively linked via some other communication media.

A given client computing platform 16 may include one or more processors configured to execute computer program modules. The computer program modules may be configured to enable one or more players associated with the given client computing platform 16 to interface with system 10 and/or external resources 14, and/or provide other functionality attributed herein to client computing platforms 16. By way of non-limiting example, the given client computing platform 16 may include one or more of a desktop computer, a laptop computer, a handheld computer, a netbook, a Smartphone, a gaming console, and/or other computing platforms.

The external resources 14 may include sources of information, hosts and/or providers of virtual environments outside of system 10, external entities participating with system 10, and/or other resources. In some implementations, some or all of the functionality attributed herein to external resources 14 may be provided by resources included in system 10.

The server 12 may be configured to provide, or cooperate with client computing platforms 16, to provide a videogame to players. This may include hosting, serving, and/or otherwise providing a virtual space to the players within which the videogame is played. The server 12 may include electronic storage 18, one or more processors 20, and/or other components. The server 12 may include communication lines, or ports to enable the exchange of information with a network and/or other computing platforms. Illustration of server 12 in FIG. 1 is not intended to be limiting. The server 12 may include a plurality of hardware, software, and/or firmware components operating together to provide the functionality attributed herein to server 12. For example, server 12 may be implemented by a cloud of computing platforms operating together as server 12.

Electronic storage 18 may comprise electronic storage media that electronically stores information. The electronic storage media of electronic storage 18 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 18 may include one or more virtual storage resources (e.g., cloud storage, a virtual private network, and/or other virtual storage resources). Electronic storage 18 may store software algorithms, information determined by processor 20, information received from server 12, information received from client computing platforms 16, and/or other information that enables server 12 to function properly.

Processor(s) 20 is configured to provide information processing capabilities in server 12. As such, processor 20 may include one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination.

As is shown in FIG. 1, processor 20 may be configured to execute one or more computer program modules. The one or more computer program modules may include one or more of a game module 22, a discovery module 24, a registry module 26, a rights module 28, a transaction module 30, and/or other modules. Processor 20 may be configured to execute modules 22, 24, 26, 28, and/or 30 by software; hardware; firmware; some combination of software, hardware, and/or firmware; and/or other mechanisms for configuring processing capabilities on processor 20.

It should be appreciated that although modules 22, 24, 26, 28, and 30 are illustrated in FIG. 1 as being co-located within a single processing unit, in implementations in which processor 20 includes multiple processing units, one or more of modules 22, 24, 26, 28, and/or 30 may be located remotely from the other modules. The description of the functionality provided by the different modules 22, 24, 26, 28, and/or 30 described below is for illustrative purposes, and is not intended to be limiting, as any of modules 22, 24, 26, 28, and/or 30 may provide more or less functionality than is described. For example, one or more of modules 22, 24, 26, 28, and/or 30 may be eliminated, and some or all of its functionality may be provided by other ones of modules 22, 24, 26, 28, and/or 30. As another example, processor 20 may be configured to execute one or more additional modules that may perform some or all of the functionality attributed below to one of modules 22, 24, 26, 28, and/or 30.

It will be appreciated that the illustration of modules 22, 24, 26, 28, and/or 30 being executed solely on processor 20 separate from client computing platforms 16 is not intended to be limiting. For example, in some implementations, the client computing platforms 16 may be configured to provide locally at least some of the functionality attributed above to one or more of modules 22, 24, 26, 28, and/or 30. Similarly, one or more of modules 22, 24, 26, 28, and/or 30 may be executed locally on individual client computing platforms 16 while others are executed on server 12.

The game module 22 may be configured to provide the videogame to players via client computing platforms 16. Providing the videogame to players may include providing videogame content to the players. The videogame content may define a virtual space. The virtual space may be hosted, served, and/or otherwise provided by game module 22. To provide the videogame to players via client computing platform 16, game module 22 and/or client computing platform 16 may generate views of the videogame (and/or the virtual space) that enable players to participate in the videogame.

A virtual space may comprise a simulated space (e.g., a physical space) that is accessible by a client (e.g., client computing platforms 16) that presents a view of the virtual space to a player. The simulated space may have a topography, express ongoing real-time interaction by the player, and/or include one or more objects positioned within the topography that are capable of locomotion within the topography. In some instances, the topography may be a 2-dimensional topography. In other instances, the topography may be a 3-dimensional topography. The topography may include dimensions of the virtual space, and/or surface features of a surface or objects that are “native” to the virtual space. In some instances, the topography may describe a surface (e.g., a ground surface) that runs through at least a substantial portion of the virtual space. In some instances, the topography may describe a volume with one or more bodies positioned therein (e.g., a simulation of gravity-deprived space with one or more celestial bodies positioned therein). A virtual space may include a virtual world, but this is not necessarily the case. For example, a virtual space may include a game space that does not include one or more of the aspects generally associated with a virtual world (e.g., gravity, a landscape, etc.). The virtual space may be synchronous (e.g., players interact within each other in the same instance of the space in real-time), asynchronous (e.g., players interact with separate instances of the same space), and/or some combination thereof.

The virtual space provided by game module 22 may be persistent. As such, the existence of topography, the objects, the non-player characters, and/or other features of the virtual space (or at least an instance of the virtual space) may be independent from whether a given player, or group of players is currently participating in the videogame in the virtual space. This persistence may lend a permanence, or substantial permanence, to possession, ownership, and/or control of objects and/or land within the virtual space by players, to relationships between players and/or non-player characters, and/or other features of the virtual space.

Within a virtual space provided by game module 22, player controlled objects may be controlled by the players to interact with the virtual space. The player controlled objects may include avatars. As used herein, the term “avatar” may refer to an object (or group of objects) present in the virtual space that represents an individual player. The avatar may be controlled by the player with which it is associated. The avatars may move through and interact with the virtual space (e.g., non-player characters in the virtual space, other objects in the virtual space). The avatar associated with a given player may be created and/or customized by the given player. The avatar may be associated with an “inventory” of virtual goods and/or currency that the player can use (e.g., by manipulation of the avatar and/or the items) within the virtual space.

The players may participate in the videogame by controlling player controlled objects in the virtual space. Control may be exercised through control inputs and/or commands input by the players through client computing platforms 16.

The game module 22 may be configured such that the videogame and/or virtual space is at least partially text-based. In such implementations, the game module 22 may generate text and/or static graphics that convey activities, events, and/or circumstances currently present and/or transpiring in the videogame. This may include other player's activities currently transpiring within the videogame. The text and/or static graphics may be presented to players via client computing platforms 16.

The discovery module 24 is configured to detect encounters of individual players of the videogame with discoverable content in the videogame. The discoverable content may include individual sets of discoverable content that are associated with discovery rights. A set of discoverable content may include, for example, a place in the videogame, a passageway from one place to another place in the videogame, an object in the videogame, a recipe in the videogame, a non-player character in the videogame, a series of control inputs associated with an attack or character animation, a hidden or partially obscured image, information about game content, and/or other sets of content.

The discovery rights for a given set of discoverable content may provide control over certain aspects of the set of discoverable content. As is discussed herein, discovery rights may be awarded to a player or players of the videogame for “discovering” the discoverable content. Since the virtual space of the videogame may be common between a plurality of players, and may be persistent independently from the plurality of players, an award of a discovery right to a player or players may be apparent to the other players of the videogame. For example, the other players may be impacted by the award of the discovery right to the player, and/or the award and/or possession of the discovery right (or the results of the exercise of the discovery right) may be observable by the other players in the videogame.

Discovery rights for a given set of discoverable content in the videogame may include rights other than (or in addition to) possession of virtual objects and/or places in the videogame. The aspects for which the discovery rights provide control over a set of discoverable content may include one or more of a name of the set of discoverable content, an ability of other players to make or use the set of discoverable content, visual presentation within the videogame, and/or other aspects of the discoverable content. A discovery right may include a right to receive a benefit for subsequent encounters with the discoverable content by other players.

Encounters with a set of discoverable content may include occasions in which players experience the set of discoverable content within the videogame. The type of experience with a given set of discoverable content that constitutes an encounter to be discoverable by discovery module 24 may be configured by an administrator of system 10, may be determined at the time that the videogame is created, installed, updated, patched, and/or otherwise configured or augmented in system 10. The type of experience with a given set of discoverable content that constitutes an encounter may differ for different types of discoverable content, and/or between different sets of discoverable content.

By way of non-limiting example, encountering a place within the videogame may include one or more of seeing the place in a view of the virtual space, positioning an object or character on the place, controlling an object (e.g., an avatar) to perform an action while positioned on or in view of the place, and/or other activities. As another example, encountering a non-player character may include one or more of capturing the non-player character, seeing the non-player character, speaking with the non-player character, defeating the non-player character, battling the non-player character, performing some other activity with the non-player character, and/or other interactions with the non-player character. Encountering an object in the videogame may include finding the object, controlling an avatar to hold the object, controlling an avatar to break the object, positioning the object into a predetermined position, and/or other interaction with the object. Encountering a recipe in the videogame (e.g., for food, a potion, an explosive, and/or other recipes) may include one or more of successfully creating the concoction according to the recipe, discovering a textual record of the recipe, obtaining an oral recitation of the recipe from an non-player character, and/or other interactions with the recipe. Encountering a series of control inputs associated with an attack or character animation may include one or more of successfully inputting the series of control inputs to achieve performance of the attack or character animation by a character (e.g., an avatar), discovering visual instructions for performing the series of control inputs, receiving instructions for performing the series of control inputs from an non-player character, and/or other interactions with the series of control inputs. These examples of encountering discoverable content are not intended to be limiting with respect to types of discoverable content and/or experiences with content that constitutes encounters.

The discovery module 24 may be configured to detect encounters with sets of discoverable content by observing interaction and/or progress of players within the videogame. This may include one or more of monitoring communications between server 12 and client computing platforms 16, monitoring operation of game module 22 on server 12 and/or on client computing platforms 16, receiving information generated by game module 22 for discovery module 24, and/or other mechanisms for monitoring interaction and/or progress of players within the videogame.

The registry module 26 may be configured to maintain a registry of discovery rights associated with sets of discoverable content. The registry may indicate assignments of individual discovery rights (and/or sets of discovery rights associated with individual sets of discoverable content) to corresponding players. Assignment of a given discovery right to a given player or group of players may indicate possession, ownership, and/or control over the given discovery right for the given player. The registry module 26 may be configured such that responsive to a detection by discovery module 24 that a set of discoverable content has been encountered by a player or group of players, registry module 26 determines whether the encountered discoverable content has previously been encountered. Responsive to determination that the encountered discoverable content has not been previously encountered, registry module 26 may be configured to assign the discovery right(s) associated with the encountered set of discoverable content to the player(s). This may include updating the registry to reflect assignment of the discovery right(s) to the player(s).

The rights module 28 may be configured to provide discovery rights to the appropriate players in the videogame. This may include providing discovery rights to the players according to the assignments of discovery rights represented in the registry maintained by registry module 26. Providing discovery rights to a player or group of players in the videogame may include providing to the player(s) the control or dominion over discoverable content afforded by the discovery rights assigned to the player(s).

By way of non-limiting example, in some implementations, a discovery right associated with a set of discoverable content may influence the presentation and/or appearance of the set of discoverable content in the videogame for any players that encounter the set of discoverable content. This may include a naming right, a right to adjust or set one or more parameters of visual, audio, or other content in the set of discoverable content, and/or other rights. In such implementations, the name given, the parameter(s) set, and/or other aspects of the discoverable content that are dictated by the player(s) in accordance with the discovery right may be perceived by other players in views of the virtual space within which the videogame takes place. In order to provide the player(s) with this type of discovery right, rights module 28 may be configured to generate a user interface for presentation to the player(s). The user interface may be configured to receive selection or entry of inputs from the player(s) dictating the presentation and/or appearance of the set of discoverable content in the videogame.

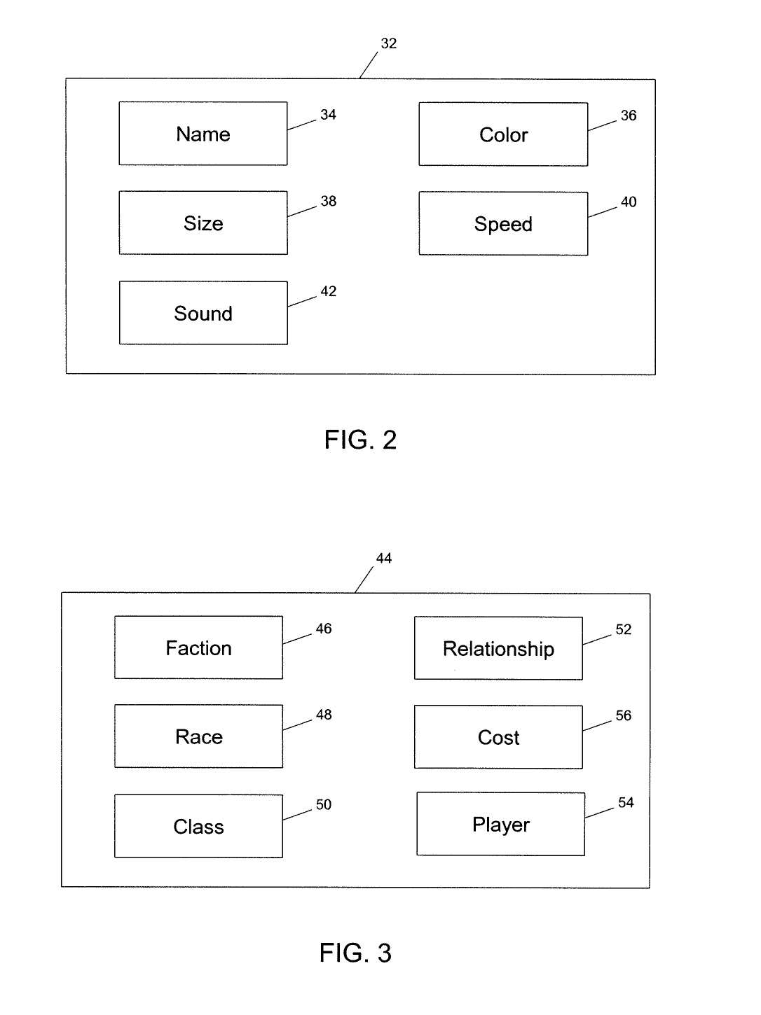

By way of illustration, FIG. 2 illustrates a user interface 32 configured to receive selection or entry of inputs from a player or group of players dictating the presentation and/or appearance of a set of discoverable content in the videogame. The user interface 32 may be presented to a player or players via electronic display associated with a client computing device (e.g., client computing device 16 shown in FIG. 1). As can be seen in FIG. 2, user interface 32 may include one or more of a name field 34, a color field 36, a size field 38, a speed field 40, a sound field 42, and/or other fields.

The name field 34 may be configured to receive entry and/or selection of a name for a set of discoverable content. Entry and/or selection may include manual entry by a player or group of players, selection of a name from a set of potential names, and/or other selections or entries. Reception of a name for a set of discoverable content via name field 34 may result in the received name being associated with the set of discoverable content for any players or group of players that encounter the set of discoverable content subsequently.

The color field 36 may be configured to receive entry and/or selection of a color for a set of discoverable content. Entry and/or selection may include manual entry by a player or players, selection of a color from a set of potential colors, selection or entry of a portion of the set of discoverable content to which the color should be applied, and/or other selections or entries. Reception of a color for a set of discoverable content via color field 36 may result in the received color being included in expressions of the set of discoverable content within the videogame.

The size field 38 may be configured to receive entry and/or selection of a size for a set of discoverable content. Entry and/or selection may include manual entry by a player or players, selection of a size from a set of potential sizes (e.g., on a sliding scale between a max and min, in discrete intervals, and/or other sets of sizes), selection or entry of a portion of the set of discoverable content that should be associated with the selected size, and/or other selections or entries. Reception of a size for a set of discoverable content via size field 38 may result in the expressions of the set of discoverable content within the videogame being provided at the selected size.

The speed field 40 may be configured to receive entry and/or selection of a speed for a set of discoverable content. Entry and/or selection may include manual entry by a player or players, selection of a size from a set of potential sizes, and/or other selections or entries. The selected and/or entered speed may include a maximum speed, a minimum speed, and/or other speeds. Reception of a speed for a set of discoverable content via speed field 40 may result in expressions of the set of discoverable content moving within views of the virtual space of the videogame in accordance with the selected speed.

The sound field 42 may be configured to receive entry and/or selection of a sound for a set of discoverable content. Entry and/or selection may include a record control that can be selected to initiate recording of a sound, selection of a sound from a set of potential sounds, entry or selection of text to be spoken, sung, or otherwise voiced, and/or other selections or entries. Reception of a sound for a set of discoverable content via sound field 42 may result in expressions of the set of discoverable content in the video game emitting the received sound.

It will be appreciated that the illustration of user interface 32 with fields 34, 36, 38, 40, and 42 is not intended to be limiting. The user interface 32 may be implemented without one or more of fields 34, 36, 38, 40, and/or 42, and/or with other fields for receiving selection of parameters of a set of discoverable content. An individual one of fields 34, 36, 38, 40, and/or 42 may be implemented as a plurality of fields.

Referring back to FIG. 1, in some implementations, a discovery right associated with a set of discoverable content may include some level of control over an ability of other players to make or use the set of discoverable content. To provide such control to a player or group of players, rights module 28 may be configured to generate a user interface configured to receive entries and/or selections that dictate aspects of the ability of other players to make or use the set of discoverable content in the videogame. The user interface may be presented to players via client computing platforms 16.

By way of illustration, FIG. 3 depicts a user interface 44 configured to receive entries and/or selections of a discovering player or group of players that dictate aspects of the ability of other players to make or use a set of discoverable content in a videogame. The user interface 44 may be configured to receive selection and/or entry from a player or group of players that indicates individual players or groups of players that should be allowed to, or prohibited from, making and/or using the set of discoverable content in the videogame. The user interface 44 may be configured to receive selection and/or entry from a player or group of players of common characteristics used to determined whether other players should be allowed to, or prohibited from, making and/or using the set of discoverable content. The user interface 44 may be configured to receive selection and/or entry of a benefit to be received the player or group of players for subsequent encounters with the set of discoverable content by other players. As can be seen in FIG. 3, user interface 44 may include one or more of a faction field 46, a race field 48, a class field 50, a relationship field 52, a player field 54, a cost field 56, and/or other fields.

The faction field 46, race field 48, class field 50, and/or other fields may be configured to receive selection and/or entry of one or more characteristics to be used in determining whether other players should subsequently be permitted to encounter the set of discoverable content. Through one or more of fields 46, 48, and/or 50, the discovering player or group of players may select or enter characteristics that define sets of characters (and/or associated players) that have or do not have the selected and/or entered characteristic(s). Through user interface 44, the discovering player or group of players may be able to configure which sets of characters will be able to and/or will not be able to subsequently encounter the set of discoverable content. The faction field 46 may be configured to receive entry and/or selection of one or more factions of characters. The race field 48 may be configured to receive selection and/or entry of one or more races of characters. The class field 50 may be configured to receive selection and/or entry of one or more classes of characters. Selection and/or entry through fields 46, 48, and/or 50 may include manual entry and/or selection from a set of potential options. Other fields configured to receive selection and/or entry of characteristics may be included in user interface 44.

The relationship field 52 may be configured to receive entry and/or selection of relationships with the discovering player (and/or his character) or group of players (and/or associated characters) required for subsequent encounters with the set of discoverable content. For example, relationship field 52 may be configured receive selection or entry of a friendship status, a guild-mate status, a raid party membership, a player-versus-player team membership, a friendship distance metric (e.g., a number of friendship relationships required to link the discovering player to another player), and/or other parameters related to relationships with the discovering player. Reception of selection and/or entry of such parameters related to relationship within the videogame may set a relationship requirement with the discovering player or group of players that other players must meet in order to subsequently encounter the set of discoverable content. For example, the relationship requirement may require another player or group of players to be a friend of the discovering player, a guild-mate of the discovering player, a fellow raid party member, a fellow player-versus-player team member, a friend-of-a-friend of the discovering player, and/or other relationship requirements.

The player field 54 may be configured to receive entry and/or selection of individual players or groups of players that should (or that should not) be permitted to encounter the set of discoverable content subsequent to discovery by the discovering player. Entry and/or selection of individual players or groups of players may include manual entry of individual players, selection of individual players from a set of potential players, and/or other entries or selections.

The cost field 56 may be configured to receive entry and/or selection of a price to be paid by other players or groups of players to the discovering player or group of players in order to be able to encounter the set of discoverable content. The price may be for a single encounter, for a specified number of encounters, for the ability to encounter the set of discoverable content for a specified time, and/or for other sets of encounters. The price may specify a cost in terms of virtual currency, real currency, virtual objects, a specific activity or action in the videogame, and/or other costs. Entry and/or selection of a price to cost field 56 may result in other players or groups of players subsequently being charged the price in order to encounter the set of discoverable content. The price paid by another player or group of players (and/or a portion thereof) may be transferred to the discovering player or group of players. One or more of fields 46, 48, 50, 52, and/or 54 may be used by the discovering player or group of players in conjunction with cost field 56 to set costs that are customizable on a per player/group and/or per player/group set basis.

It will be appreciated that the illustration of user interface 44 with fields 46, 48, 52, 54, and 56 is not intended to be limiting. The user interface 32 may be implemented without one or more of fields 46, 48, 50, 52, 54, and 56, and/or with other fields for receiving selection of parameters of a set of discoverable content. An individual one of fields 46, 48, 50, 52, 54, and/or 56 may be implemented as a plurality of fields.

Turning back to FIG. 1, as has been set forth, in some implementations a discovering player or group of players may be entitled to payment from other players or groups of players for subsequent encounters with a set of discoverable content. In such implementations, discovery module 24 may detect a subsequent encounter, or attempted encounter, of the set of discoverable content by another player or group of players. Responsive to this detection, registry module 26 may determine that the discovery rights associated with the set of discoverable content are assigned to the discovering player(s). Based on this determination, rights module 28 may determine the scope of the discovery rights associated with the set of discoverable content. The rights module 28 may then selectively permit the other player or group of players to fully encounter the set of discoverable content, subject to the limitations, controls, and/or alterations set by the discovering player(s) in accordance with the discovery rights. This may include one or more of presenting a name for the discoverable content that has been given by the discovering player(s), permitting and/or denying access to the set of discoverable content, requiring the other player(s) to pay the appropriate price for access to the set of discoverable content, and/or other actions.

In some implementations, the detection of another player or group of players encountering (or attempting to encounter) the set of discoverable content may prompt rights module 28 to generate a user interface for presentation to the discovering player(s). The user interface may present information about the other player or group of players and/or the circumstances surrounding the encounter, or attempted encounter, with the set discoverable content. The user interface may be configured to receive selection and/or entry from the discovering player(s) of a permission or denial of permission for the other player(s) to access the set of discoverable content. The user interface may be presented to the discovering player(s) via an electronic display of one of client computing platforms 16.

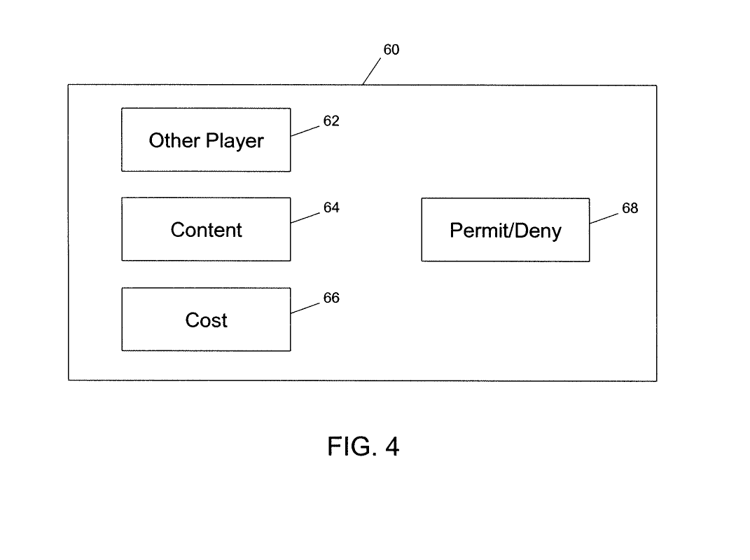

By way of illustration, FIG. 4 depicts a user interface 60 that may be presented to a discovering player or group of players responsive to another player or group of players encountering, or attempting to encounter, a set of discoverable content previously discovered by the discovering player(s). The user interface 60 may include one or more of a player or group information field 62, a content information field 64, a cost field 66, a permit/deny field 68, and/or other fields.

The player information field 62 may be configured to present to the discovering player or group of players information related to the other player(s). The information may include one or more of a player name, a character name, a character level, a faction, a race, a class, a level, relationship information, alliance information, health information, a message from the other player(s) to the discovering player(s), and/or other information.

The content information field 64 may be configured to present to the discovering player information related to the set of discoverable content. The information may include one or more of a content name, a content state, and/or other information.

The cost field 66 may be configured to receive entry and/or selection of a price being requested by the discovering player or group of players for access to the set of discoverable content. The price would be payable by the other player(s), and for receipt (at least in part) by the discovering player or group of players. The price may include one or more of an amount of virtual currency, an amount of real world currency, a set of one or more virtual objects, information, an alliance, and/or other items of value. Entry and/or selection of the price may include manual entry by the discovering player(s), and/or selection of the price from a set of potential prices.

The permit/deny field 68 may be configured to receive entry and/or selection by the discovering player or group of players of permission and/or denial for access of the set of discoverable content by the other player or group of players. Permission for access of the set of discoverable content by the other player(s) may result in the other player(s) being granted access to the set of discoverable content. Denial for access of the set of discoverable content by the other player(s) may result in the other player being denied access to the set of discoverable content. Permission and/or denial for access to the set of discoverable content may be entered and/or selected for a specific number of times, for a specific amount of time, for an unlimited number of times, for an unlimited amount of time, and/or on other basis.

It will be appreciated that the illustration of user interface 60 with fields 62, 64, 66, and 68 is not intended to be limiting. The user interface 60 may be implemented without one or more of fields 62, 64, 66, and/or 68, and/or with other fields for receiving selection of parameters of a set of discoverable content. An individual one of fields 62, 64, 66, and/or 68 may be implemented as a plurality of fields.

Referring back to FIG. 1, the transaction module 30 may be configured to facilitate transactions between players or groups of players in which discovery rights for sets of discoverable content can be bought, sold, traded, given, and/or otherwise exchanged between players or groups of players. Such transactions may involve exchanges of, in addition to discovery rights, virtual currency, real world currency, information, virtual objects, alliances, relationships, and/or other consideration. A transaction between a discovering player or group of players and another player or group of players of a discovery right may result in the registry maintained by registry module 26 indicating that the discovery right is assigned to the other player or group of players. Discovery rights may be exchanged individually and/or in sets that correspond to individual sets of discoverable content.

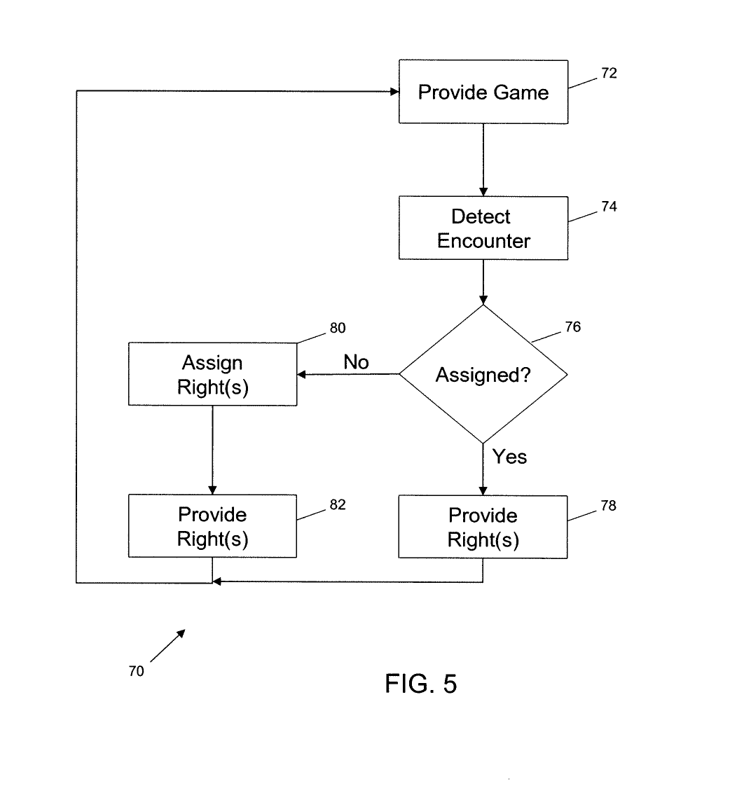

FIG. 5 illustrates a method 70 of providing discovery rights to players or groups of players within a videogame that takes place in a virtual space. The operations of method 70 presented below are intended to be illustrative. In some embodiments, method 20 may be accomplished with one or more additional operations not described, and/or without one or more of the operations discussed. Additionally, the order in which the operations of method 70 are illustrated in FIG. 5 and described below is not intended to be limiting.

In some embodiments, method 70 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 70 in response to instructions stored electronically on an electronic storage medium. The one or more processing devices may include one or more devices configured through hardware, firmware, and/or software to be specifically designed for execution of one or more of the operations of method 70.

At an operation 72, the videogame is provided to a player or group of players. This may include generating views of a virtual space within which the videogame takes place. Providing the videogame may include enabling the player(s) to interact with the videogame by controlling one or more objects within the virtual space. In some implementations, operation 72 may be performed by a game module the same as or similar to game module 22 (shown in FIG. 1 and described herein).

At an operation 74, an encounter of the player(s) with a set of discoverable content may be detected. In some implementations, operation 74 may be performed by a discovery module the same as or similar to discovery module 24 (shown in FIG. 1 and described above).

At an operation 76, a determination may be made as to whether a discovery right associated with the discoverable content has been assigned to any player(s) or group(s) of players. This may include accessing a registry of discovery rights associated with sets of discoverable content in the videogame. Responsive to a determination that the discovery right has previously been assigned to another player or group of players, method 70 may proceed to an operation 78. Responsive to a determination that the discovery right has not previously been assigned to another player or group of players, method 70 may proceed to an operation 80. In some implementations, operation 76 may be performed by a registry module the same as or similar to registry module 26 (shown in FIG. 1 and described herein).

At operation 80, the discovery right may be assigned to the discovering player or group of players. Assigning the discovery right to the discovering player or group of players may include updating the registry to reflect this assignment. In some implementations, operation 80 may be performed by a registry module the same as or similar to registry module 26 (shown in FIG. 1 and described herein).

At an operation 82, the discovery right may be provided to the discovering player or group of players. This may include receiving entry and/or selection of inputs from the discovering player or group of players configuring implementation of the discovery right. Reception and/or entry of the inputs may be accomplished via a user interface presented to the discovering player or group of players. Providing the discovery right to the discovering player(s) may include providing the set of discoverable content to other players of the videogame subject to the control exerted over the set of discoverable content by the discovering player(s) by virtue of the discovery right. In some implementations, operation 82 may be accomplished by a rights module the same as or similar to rights module 28 (shown in FIG. 1 and described above).

At operation 78, the set of discoverable content is provided to the player or group of players subject to the control exerted over the set of discoverable content by the other player(s) by virtue of the assignment of the discovery right to the other player or group of players. In some implementations, operation 78 is performed by a rights module the same as or similar to rights module 28 (shown in FIG. 1 and described above).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to assign rights to discoverable in-game content to users, the system comprising:
one or more processors configured to execute computer program modules, the computer program modules comprising:
a game module configured to generate views of a videogame for presentation to players that enable the individual players to participate in the videogame by controlling corresponding player controlled objects within the videogame, the videogame comprising a plurality of sets of discoverable content, wherein individual sets of discoverable content are associated with corresponding discovery rights;
a discovery module configured to detect encounters of individual sets of discoverable content by the player while participating in the videogame;
a registry module configured to maintain a registry of discovery rights associated with sets of discoverable content that are assigned to players in the videogame such that responsive to detection by the discovery module of an encounter of the player with a first set of discoverable content, the registry module determines whether a first discovery right associated with the first set of discoverable content is assigned to any player, and wherein the registry module is further configured such that responsive to determination that the first discovery right has not been assigned to any player, the first discovery right is assigned to the player; and
a rights module configured such that responsive to assignment of the first discovery right to the player the first discovery right is provided to the player in the videogame.

2. The system of claim 1, wherein the first discovery right comprises a naming right such that providing the first discovery right to the player includes receiving a name for the first set of discoverable content in the videogame, and associating the received name with the first set of discoverable content during subsequent encounters with the first set of discoverable content by other players.

3. The system of claim 1, wherein the first discovery right comprises a right to a benefit for subsequent encounters with the first set of discoverable content by other players such that providing the first discovery right to the player includes bestowing the benefit to the player responsive to a subsequent encounter with the first set of discoverable content by another player.

4. The system of claim 1, wherein the first discovery right comprises a right to exclude other players from subsequently encountering the first set of discoverable content such that providing the first discovery right to the player includes selectively excluding other players from subsequently encountering the first set of discoverable content responsive to input from the player.

5. The system of claim 4, wherein the rights module is configured such that other players are selectively excluded from subsequently encountering the first set of discoverable content responsive to input from the player that indicates whether the other players should receive access to the first set of discoverable content on an individual basis.

6. The system of claim 4, wherein the rights module is configured such that other players are selectively excluded from subsequently encountering the first set of discoverable content responsive to input from the player that indicates a common characteristic that should be used to determine whether other players should receive access to the first set of discoverable content.

7. The system of claim 4, wherein the rights module is configured such that the input from the player includes a price to be paid by other players for subsequent access to the first set of discoverable content.

8. The system of claim 1, wherein the first set of discoverable content comprises one or more of a place in the videogame, an object in the videogame, a recipe in the videogame, a non-player character in the videogame, a series of control inputs associated with an attack or character animation, a hidden or partially obscured image, or information about game content.

9. The system of claim 1, wherein the first discovery right has an expiration period, a number of uses limitation, a maximum accrual of one or more benefits, a conditional requirement to activate controls and/or benefits, or a condition causing loss of rights.

10. A method of assigning rights to discoverable in-game content to users, the method being implemented in a computer system having one or more processors configured to execute one or more computer program modules, the method comprising:
generating views of a videogame for presentation to players that enable the individual players to participate in the videogame by controlling corresponding player controlled objects within the videogame, the videogame comprising a plurality of sets of discoverable content, wherein individual sets of discoverable content are associated with corresponding discovery rights;
detecting encounters of individual sets of discoverable content by the player while participating in the videogame;
maintaining a registry of discovery rights associated with sets of discoverable content that are assigned to players in the videogame such that responsive to detection by the discovery module of an encounter of the player with a first set of discoverable content, a determination is made as to whether a first discovery right associated with the first set of discoverable content is assigned to any player, and, responsive to determination that the first discovery right has not been assigned to any player, the first discovery right is assigned to the player; and
responsive to assignment of the first discovery right to the player, providing the first discovery right to the player in the videogame.

11. The method of claim 10, wherein the first discovery right comprises a naming right such that providing the first discovery right to the player includes:
receiving a name for the first set of discoverable content in the videogame, and
associating the received name with the first set of discoverable content during subsequent encounters with the first set of discoverable content by other players.

12. The method of claim 10, wherein the first discovery right comprises a right to a benefit for subsequent encounters with the first set of discoverable content by other players such that providing the first discovery right to the player includes bestowing the benefit to the player responsive to a subsequent encounter with the first set of discoverable content by another player.

13. The method of claim 10, wherein the first discovery right comprises a right to exclude other players from subsequently encountering the first set of discoverable content such that providing the first discovery right to the player includes selectively excluding other players from subsequently encountering the first set of discoverable content responsive to input from the player.

14. The method of claim 13, wherein the input from the player indicates whether the other players should receive access to the first set of discoverable content on an individual basis.

15. The method of claim 13, wherein the input from the player indicates a common characteristic that should be used to determine whether other players should receive access to the first set of discoverable content.

16. The method of claim 13, wherein the input from the player includes a price to be paid by other players for subsequent access to the first set of discoverable content.

17. The method of claim 10, wherein the first set of discoverable content comprises one or more of a place in the videogame, an object in the videogame, a recipe in the videogame, a non-player character in the videogame, a series of control inputs associated with an attack or character animation, a hidden or partially obscured image, or information about game content.

18. The system of claim 1, wherein the first discovery right has an expiration period, a number of uses limitation, a maximum accrual of one or more benefits, a conditional requirement to activate controls and/or benefits, or a condition causing loss of rights.
